(19) United States
(12) Patent Application Publication
(10) Pub. No.: US 2023/0097515 A1
(43) Pub. Date: Mar. 30, 2023

(54) COMBINED AUTHORIZATION FOR ENTITIES WITHIN A DOMAIN

(71) Applicant: Oracle International Corporation, Redwood Shores, CA (US)

(72) Inventors: Gregg Alan Wilson, Austin, TX (US); Thomas James Andrews, Seattle, WA (US); Gary Philip Cole, Austin, TX (US); Girishi Nagaraja, Sammamish, WA (US); Bhavitha Chava, Khammam (IN)

(73) Assignee: Oracle International Corporation, Redwood Shores, CA (US)

(21) Appl. No.: 17/957,522

(22) Filed: Sep. 30, 2022

Related U.S. Application Data
(60) Provisional application No. 63/250,805, filed on Sep. 30, 2021.

(51) Int. Cl. H04L 9/40

(52) U.S. Cl. CPC H04L 63/0815

(57) ABSTRACT

Systems and methods for combined authorization for entities within a domain are described. One aspect relates to a method. The method can include receiving a request for a user to take an action in a first system and determining a first authorization status of the action by the user with the first system. The method can include determining a second authorization status of the action by the user with a second system, determining a union of the first authorization status and the second authorization status, and comparing the union of the first authorization status and the second authorization status to authorization criteria.

### CROSS-REFERENCES TO RELATED APPLICATIONS

This application claims the benefit of U.S. Provisional Application No. 63/250,805, Filed on Sep. 30, 2021, and entitled “Combined Authorization for Entities Within a Domain,” the entirety of which is hereby incorporated by reference herein.

### BACKGROUND

The adoption of cloud services has seen a rapid uptick in recent times. Various types of cloud services are now provided by different cloud service providers (CSPs). The term cloud service is generally used to refer to a service or functionality that is made available by a CSP to subscribing customers on demand, typically using a subscription model, using systems and infrastructure (commonly referred to as cloud infrastructure) provided by the CSP. Typically, the servers and systems included in the CSP-provided cloud infrastructure that is used to provide a cloud service to a subscribing customer are separate from the customer's own on-premise servers and systems. The CSP-provided infrastructure can include compute, storage, and networking resources. Customers can thus avail themselves of cloud services provided by the CSP without having to purchase their own hardware and software resources for the services. Cloud services are designed to provide a subscribing customer easy, scalable, and on-demand access to applications and computing resources without the customer having to invest in procuring the infrastructure for providing the services or functions. Various types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

Different services offered by a CSP may have different authorization processes and different permissions. In some instances, these different authorization processes and permissions can result in an unsatisfactory customer experience. Accordingly, further improvements are desired.

### BRIEF SUMMARY

Aspects of the present disclosure relate to systems and methods for combined authorization. One aspect relates to a method. The method can include receiving a request for a user to take an action in a first system, determining a first authorization status of the action by the user with the first system, determining a second authorization status of the action by the user with a second system, determining a union of the first authorization status and the second authorization status, and comparing the union of the first authorization status and the second authorization status to authorization criteria.

In some embodiments, the method further includes allowing the action by the user when the union of the first authorization status and the second authorization status comply with the authorization criteria. In some embodiments, the union of the first authorization status and the second authorization status complies with the authorization criteria when the union of the first authorization status and the second authorization status includes authorization from each of the first system and the second system for the user to take the action. In some embodiments, the method further includes allowing the action by the user when the union of the first authorization status and the second authorization status includes authorization from at least one of the first system and the second system for the user to take the action.

In some embodiments, the method includes denying the action by the user when the union of the first authorization status and the second authorization status does not comply with the authorization criteria. In some embodiments, the union of the first authorization status and the second authorization status does not comply with the authorization criteria when the union of the first authorization status and the second authorization status includes a denial of authorization from at least one of the first system and the second system.

In some embodiments, the first system is a role-based access control (RBAC) system, and the second system is an attribute-based access control (ABAC) system. In some embodiments, receiving the request for the user to take the action in the first system includes receiving a signed request from a first application associated with the first system. In some embodiments, receiving the request for the user to take the action in the first system includes receiving information identifying: the first application; the user; the action; and an endpoint to be affected by the action.

In some embodiments, the first system validates the signed request and derives an involved principal with the second system based on at least one of: the received signed request; and the received information. In some embodiments, validating the signed request includes: the second system requesting and receiving a public key from a data plane; and validating the signed request with the public key. In some embodiments, determining the first authorization status of the action by the user with the first system includes determining a domain-specific authorization of the involved principal. In some embodiments, the domain-specific authorization of the involved principal is determined according to authorization policies of the first system.

In some embodiments, determining the first authorization status of the action by the user with the first system includes evaluating the request to take action according to authorization policies of the first system. In some embodiments, determining the second authorization status of the action by the user with the second system includes: mapping the authorization policy of the first system to a corresponding authorization policy of the second system based at least in part on the received information. In some embodiments, evaluating the request to take action according to authorization policies of the first system includes: identifying a role of the user and a domain of the user; retrieving permissions associated with the role of the user and the domain of the user; and determining that the received information identifies an action allowed by the retrieved permissions. In some embodiments, determining the second authorization status of the action by the user with the second system further includes: determining a principal of the user; retrieve access policies relevant to the received request; determining that the received request identifies an action allowed by the retrieved access policies.

One aspect relates to a system. The system includes a first access control system including at least one first processor, and a memory including a plurality of instructions executable by the at least one first processor. The system includes a second access control system that can determine a second authorization status for a requested user action. The first access control system can receive a request for a user to take an action in the first access control system, determine a first authorization status of the action by the user, receive authorization information for the action from the second system, determine a union of the first authorization status and the second authorization status, and compare the union of the first authorization status and the second authorization status to authorization criteria.

In some embodiments, receiving the request for the user to take the action in the first system includes receiving a signed request from a first application associated with the first system. In some embodiments, receiving the request for the user to take the action in the first system includes receiving information identifying the first application, the user, the action, and an endpoint to be affected by the action. In some embodiments, the first system validates the signed request and derives an involved principal with the second system based on at least one of the received signed request, and the received information.

One aspect relates to a non-transitory computer-readable storage medium storing a plurality of instructions executable by one or more processors. When executed by the one or more processor, the plurality of instructions cause the one or more processors to receive a request for a user to take an action in a first system, determine a first authorization status of the action by the user with the first system, determine a second authorization status of the action by the user with a second system, determine a union of the first authorization status and the second authorization status, and compare the union of the first authorization status and the second authorization status to authorization criteria.

In some embodiments, receiving the request for the user to take the action in the first system includes receiving a signed request from a first application associated with the first system. In some embodiments, receiving the request for the user to take the action in the first system includes receiving information identifying the first application, the user, the action, and an endpoint to be affected by the action. In some embodiments, the first system validates the signed request and derives an involved principal with the second system based on at least one of the received signed request, and the received information.

### BRIEF DESCRIPTION OF THE DRAWINGS

FIG. 1 is a schematic illustration of one embodiment of the system for combined authorization for entities within a domain.

FIG. 2 is a flowchart illustrating one embodiment of a process for combined authorization for entities within a domain.

FIG. 3 is a flowchart illustrating another embodiment of a process for combined authorization for entities within a domain.

FIG. 4 is a block diagram illustrating one pattern for implementing a cloud infrastructure as a service system, according to at least one embodiment.

FIG. 5 is a block diagram illustrating another pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to cloud computing, and specifically relates to authorizations and permissions, and specifically relates to combined authorizations for entities within a domain.

A CSP provides the infrastructure and resources that are used for providing cloud services to subscribing customers. The CSP-provided resources can include hardware and software resources. These resources can include, for example, compute resources (e.g., computer systems, virtual machines, containers, applications, processors), memory resources (e.g., databases, data stores), networking resources (e.g., routers, load balancers), identity and access management resources, and other resources. The resources provided by a CSP for providing a set of cloud services to subscribing customers are typically organized into data centers, each data center comprising one or more computing systems or host machines. A data center may be configured to provide a particular set of cloud services. The CSP is responsible for equipping and configuring the data center with compute, memory, and networking and resources that are used to provide that particular set of cloud services. A CSP may provide one or more data centers depending upon the number of subscribing customers and based upon the locations of the customers.

Data centers provided by a CSP may be hosted in different geographical regions. A region may refer to a particular geographic area and may be identified by a region name. Regions are generally independent of each other and can be separated by vast distances, such as across countries or even continents. Examples of regions for a CSP may include US West, US East, Australia East, Australia Southeast, and the like. In certain implementations, a collection of regions is referred to as a realm. A realm can include one or more regions. Accordingly, a CSP may provide a realm comprising one or more regions, with each region including one or more data centers.

Each data center is thus associated with a region. A CSP may deploy one or more data centers in a region, where the data centers are located within some certain geographic area (e.g., a city) within the region. For example, a particular CSP may have multiple regions such as US West region, US East region, Australia East region, Australia Southeast region, and the like. The CSP may deploy one or more data centers in each region, such as in a city within the region. For example, one or more data centers for the US West region may be located in San Jose, Calif.; data centers for the US East region may be located in Ashburn, Va.; one or more data centers for the Australia East region may be located in Sydney, Australia; one or more data centers for the Australia Southeast region may be located in Melbourne, Australia; and the like. The data centers in two different regions may provide the same or a different set of cloud services and resources to subscribing customers.

In certain implementations, in order to provide high availability to customers and for disaster recovery purposes, data centers within a region may further be organized into one or more availability domains, with an availability domain including one or more data centers. Availability domains within a region are isolated from each other, are made fault tolerant, and are architected in such a way that data centers in multiple availability domains in a region are very unlikely to fail simultaneously. For example, the availability domains within a region may be structured such that a failure at one availability domain within the region is unlikely to impact the availability of data centers in other availability domains within the same region.

A cloud service provider (CSP) may provide multiple cloud services to subscribing customers. These services may be provided under different models including a Software-as-a-Service (SaaS), Platform-as-a-Service (PaaS), an Infrastructure-as-a-Service (IaaS) model, and others.

In the cloud environment, an identity management system is generally provided by the CSP to control user access to resources provided or used by a cloud service. Typical services or functions provided by an identity management system include, without restriction, single sign-on capabilities for users, authentication and authorization services, and other identity-based services.

The resources that are protected by an identity management system can be of different types such as compute instances, block storage volumes, virtual cloud networks (VCNs), subnets, route tables, various callable APIs, internal or legacy applications, and the like. These resources include resources stored in the cloud and/or customer on-premise resources. Each resource is typically identified by a unique identifier (e.g., an ID) that is assigned to the resource when the resource is created.

A CSP may provide two or more two separate and independent identity management systems for their cloud offerings. This may be done, for example, where a first identity management system or platform (e.g., Infrastructure Identity and Access Management (IAM)) may be provided for controlling access to cloud resources for IaaS applications and services provided by the CSP. Separately, a second identity management system or platform (e.g., Identity Cloud Services (IDCS)) may be provided for security and identity management for SaaS and PaaS services provided by the CSP.

As a result of providing such two separate platforms, if a customer of the CSP subscribes to both a SaaS or PaaS service and an IaaS service provided by the CSP, the customer currently has two separate accounts—one account with IAM for the IaaS subscription and a separate account with IDCS for the PaaS/SaaS subscription. Each account has its own credentials, such as user login, password, etc. The same customer thus has two separate sets of credentials. This results in an unsatisfactory customer experience and potentially an increase security risks as customers have to maintain two different sets of credentials and as credentials are maintained in two systems. Additionally, having two separate identity management system also creates obstacles for interactions between SaaS/PaaS and IaaS services.

For purposes of this application, and as examples, the two platforms will be referred to as IAM and IDCS. These names and terms are not intended to be limiting in any manner. The disclosure described herein applies to any two (or more) identity management systems that are to be integrated. The identity management systems or platforms may be provided by one or more CSPs.

In certain embodiments, an integrated identity management platform is provided that integrates the multiple identity management platforms (e.g., IAM and IDCS platforms) provided by the CSP in a manner that is transparent to the users or customers of the cloud services while retaining and offering the various features and functionalities offered by the two separate (e.g., IAM and IDCS) platforms. The integration thus provides a more seamless and enhanced user experience.

However, this integration is technically very difficult because the two platforms may use different procedures and protocols for implementing the identity-related functions. IAM may, for example, be an attribute-based access control (ABAC) system, also known as policy-based access control system, which defines an access control paradigm whereby access rights are granted to users through the use of policies that express a complex Boolean rule set that can evaluate many different attributes. The purpose of ABAC is to protect objects such as data, network devices, and IT resources from unauthorized users and actions—those that don't have “approved” characteristics as defined by an organization's security policies. On the other hand IDCS may be a role-based access control (RBAC) system which is a policy-neutral access-control mechanism defined around roles and privileges. The components of RBAC such as role-permissions, user-role and role-role relationships make it simple to perform user assignments. As yet another example, authentication and authorization frameworks or workflows (e.g., types of tokens that are used, different authentication frameworks such as OAUTH, etc.) used by the two platforms may be different. Accordingly, providing an integrated solution is technically very difficult.

To solve this problem, a combined authorization for entities within a domain is developed. This combined authorization for entities within a domain can combine authorizations of IAM and of IDCS. The combined authorization for entities within a domain avoids problems arising when there is a disparity in authorizations for a user within different systems. This can, for example, include when a user in a first system is assigned to a role that is given certain rights in that first system, whereas that user is also a principal in the second system and is given certain rights in the second system. The combined authorization for entities within a domain receives a request from a user to perform some action, and then determines whether the user is authorized to perform that action by the first system, and then determines whether the user is authorized to perform that action in the second system. Having received authorization information for the first system and the second system, the union of that authorization information can be determined, and then compared to one or several authorization criteria. Based on this comparison to the one or several authorization criteria, the user is either allowed to take the requested action, or prevented from taking the requested action.

Because the combined authorization for entities within a domain utilizes permissions from both the first and second system, and determines a union of those permissions, problems associated with multiple separate authorizations and discrepancies in those authorizations are remedied.

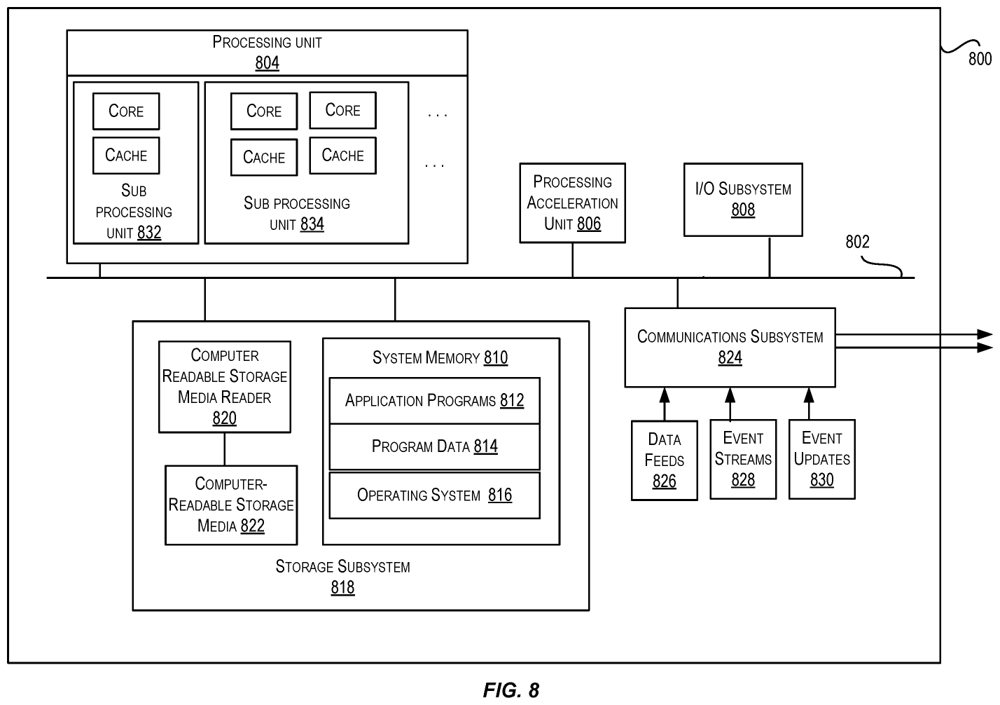

The term “data center,” as used in this disclosure, refers to one or more computer systems that together are used to implement the data center. For example, a home region data center refers to one or more computer systems that are used to implement a data center in a home region. For example, a global region data center refers to one or more computer systems used to implement the global region data center. A computer system that makes up a data center can include one or more processors, and one or more memories capable of storing instructions that are executed by the one or more processors. An example of such a computer system is depicted in FIG. 8 and described below.

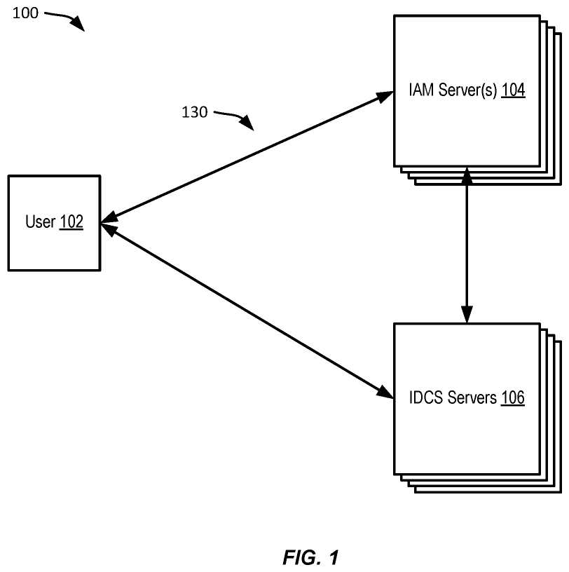

With reference now to FIG. 1, a schematic illustration of one embodiment of the system for combined authorization for entities within a domain 100, also referred to herein as an combined authorization system 100 is shown. The system 100 includes a user device 102, one or several IAM servers 104, and one or several IDCS servers 106. In some embodiments, the user device 102 can comprise a computing device such as a laptop, a desktop, a mobile device, and the like. The one or several IAM servers 104 and/or the one or several IDCS servers 106 can each comprise one or several computing resources including, for example, one or several servers or server racks. The one or several IAM server 104 and/or the one or several ICDS servers 106 can be located in one or several of the global region 102, the home region 112, and/or the non-home region 122.

A user can, with user device 102, request authorization to take an action via one or several IAM applications running on one or several IAM servers 104, or via one or several IDCS applications running on one or several IDCS servers 106. In some embodiments, the user device 102 can be directly connected with one or both of at least one IAM server 104 and at least one IDCS server 106 via, for example, a wired or wireless connection via, for example, a communication network 130. In some embodiments, the user device 102 can be directly connected with one or both of at least one IAM server 104 and at least one IDCS server 106 via, for example, one or several communication networks and/or one or several computer networks. In some embodiments, the user device 102 can be directly connected with one or both of at least one IAM server 104 and at least one IDCS server 106 via, for example, the internet.

In some embodiments, some or all of the IAM server(s) 104 and the IDCS server(s) 106 can be located at a same location, or at different locations. In some embodiments, some or all of the IAM server(s) 104 and the IDCS server(s) 106 can be located in different computing networks, different data centers, different regions, or the like. In some embodiments, and applying combined authorization systems 100 as disclosed herein, when a user receives authorization to take an action from the IDCS server 106, this can receiving authorization from the IAM server 104.

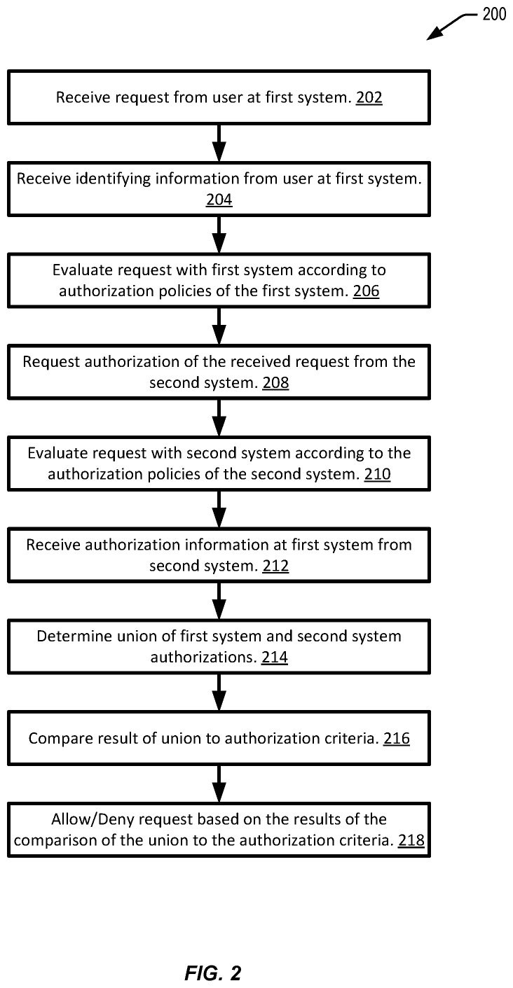

With reference now to FIG. 2, a flowchart illustrating one embodiment of a process 200 for combined authorization for entities within a domain is shown. The process 200 can be performed by all or portions of the combined authorization system 100, and specifically can be performed by one or several of the IDCS servers 106 and/or by one or several of the IAM servers 104. In some embodiments, one or several of the IDCS server 106 can be the first system and one or several of the IAM servers 104 can be the second system, and in some embodiments, one or several of the IAM servers 104 can be the first system and one or several of the IDCS servers 106 can be the second system. Thus, in some embodiments, the first system can be an RBAC system and the second system can be an ABAC system, whereas in other embodiments, the first system can be the ABAC system and the second system can be the RBAC system.

In some embodiments, the process 200 begins at block 202, wherein a request is received by a first system from a user. This request can be made by a user, within a domain, and requesting to take a specific action on a specific endpoint. In some embodiments, the user can be accessing an application, and specifically an Application Programming Interface (API) within the first system. In some embodiments, this can include the user accessing an application, and specifically an API within a domain of the IDCS system 106. In such an embodiment, the IDCS system 106 can receive the request from the user device 102, and specifically from the application, and more specifically from the API. In some embodiments, the request can comprise a signed request and/or can include one or several tokens for use in identifying the user and/or authenticating the request.

At block 204, identifying information is received from the user at the first system. This identifying information can be part of the request received in block 202, or can be separate from the request received in block 202. In some embodiments, this information can be generated by the application, and specifically through the API, through which the request is generated. This information can identify, for example, the user requesting to take the action, the current domain of the user, the action requested by the user, and the endpoint affected by the action. In some embodiments, the information can comprise a signed request and/or can include one or several tokens for use in identifying the user and/or authenticating the request.

At block 206, the request is evaluated by the first system according to authorization policies of the first system. In some embodiments, this can include receiving the signed request and validating the signed request and/or determining an involved principal associated with the request. In some embodiments, the involved principal can be the principal of the user making the request. In some embodiments, this principal can be a principal in the first system that can be associated with one or several roles and/or can be a principal in the second system associated with one or several attributes. In some embodiments, the principal of the user can be, in fact, a first principal of the first system and a second principal of the second system.

In some embodiments, the first system can validate the signed request based on the information contained in the received request and/or based on otherwise available information. In some embodiments, for example, the request can be signed with a private key. In such an embodiment, the public key can be utilized to validate the signed request. In some embodiments, the first system can request the public key from, for example, the data plane, and upon receipt of the public key, can validate the signed request. In some embodiments, the first system can send the signed request to the second system, which second system can request and receive the public key from the data plane. Upon receipt of the public key from the data plane, the second system can validate the signed request with the received public key.

In some embodiments, the first system can determine the principal of the user and/or in some embodiments, the second system can determine the principal of the user. In some embodiments, for example in which the principal comprises a first principal of the first system and a second principal of the second system, the first system can determine the first principal, and the second system can determine the second principal. In some embodiments, principal, which can include one or both of the first principal and the second principal can be determined based on the request and/or on the received information.

In some embodiments, evaluating the request by the first system according to authorization policies of the first system can include determining a first authorization status of the received request. In some embodiments, determining the first authorization status can include determining a domain-specific authorization for the received request. In some embodiments, this domain-specific authorization can be based on the determined principal.

The domain specific authorization of the principal can be determined by the first system. In some embodiments, this domain specific authorization of the principal can be determined by the first system according to the authorization policies of the first system, and can include, for example, evaluating the request to take action according to authorization policies of the first system. In some embodiments, this can include identifying a role of the user and a domain of the user. The first system can retrieve permissions associated with the role of the user and/or with the domain of the user. The first system can determine based on the retrieved permissions, and based on the request and the attributes of the request if the requested action is an allowed action. In some embodiments, this can include determining based on the retrieved permissions and based on the user, the user role, the user domain, the affected endpoint, and the requested action, whether the requested action is allowed by the retrieved permissions. If it is determined that the request is allowed by the one or several permissions, authorization policies, and/or access policies, then the first system indicates that the action is allowed. If it is determined that the request is prohibited by the one or several permissions, authorization policies, and/or access policies, then the first system indicates that the action is prohibited. In some embodiments, if it is determined that the request is neither allowed nor prohibited by the one or several permissions, authorization policies, and/or access policies, then no indication of authorization is generated by the first system.

At block 208, the first system requests authorization of the received request from the second system. In some embodiments, this can include the IDCS requesting authorization of the received request from the IAM. In some embodiments, this can include determining a permission and/or authorization policies in the second system corresponding to the permission and/or authorization policies in the first system relevant to the received request, or in other words, mapping one or several permissions and/or authorization policies in the first system to one or several corresponding permissions and/or authorization policies in the second system. In some embodiments, the first system can include a database linking one or several permissions and/or authorization policies of the first system to one or several permissions and/or authorization policies of the second system. In some embodiments, the first system requesting authorization of the received request from the second system can include the first system querying the database, based on the received request and/or received information, for identification of the one or several permissions and/or authorization policies of the second system.

In some embodiments, an upon identifying the one or several permissions and/or authorization policies in the second system relevant to the received request, the first system can query the second system for an authorization determination of the received request. In some embodiments, the first system can send an authorization request to the second system, which authorization request can identify the one or several relevant permissions and/or authorization policies, and can include the request received in block 202 and/or information relating to the request received in block 202. This information can include, for example, the user, the user role, the user domain, the affected endpoint, and/or the requested action.

At block 210, the second system evaluates the request of block 202 according to authorization policies of the second system. In some embodiments, this can include determining a second authorization status for the requested action of block 202. This can include, for example, determining and/or identifying the principal of the user for the request, retrieving one or several permissions, authorization policies, and/or access policies relevant to the received request and/or to the identified principal of the user, and determining whether the received request of block 202 is allowed by the retrieved one or several permissions, authorization policies, and/or access policies and/or whether the action identified by the request of block 202 is allowed by the one or several permissions, authorization policies, and/or access policies. In some embodiments, the one or several permissions, authorization policies, and/or access policies can be identified based on information received from the first system in block 208. If it is determined that the request is allowed by the one or several permissions, authorization policies, and/or access policies, then the second system indicates that the action is allowed. If it is determined that the request is prohibited by the one or several permissions, authorization policies, and/or access policies, then the second system indicates that the action is prohibited. In some embodiments, if it is determined that the request is neither allowed nor prohibited by the one or several permissions, authorization policies, and/or access policies, then no indication of authorization is generated.

At block 212, authorization information from the second system is received. In some embodiments, this can include receiving the authorization information from the second system at the first system. At block 214, the union of the first system authorization and the second system authorization of the request received in block 202 is determined, in other words, a union of the first authorization status and the second authorization status is determined.

At block 216, the union of the first system authorization and the second system authorization is compared to one or several authorization criteria. In some embodiments, the authorization criteria can delineate between unions sufficient to authorize the request of block 202 and those insufficient to authorize the request of block 202. In some embodiments, the authorization criteria can identify a union a sufficient to authorize the request of block 202 when both of the first authorization status and the second authorization status authorize the request, or when one of the first authorization status and the second authorization status authorize the request and the other does not prohibit the request. In some embodiments, the authorization criteria can identify the union as insufficient to authorize the request of block 202 when at least one of the first authorization status and the second authorization status prohibits authorization of the request.

At block 218, the request of block 202 is either allowed or denied based on the results of the comparison of the union of the first system authorization and the second system authorization to the authorization criteria. Thus, in some embodiments, the request, and specifically the action requested by the user can be authorized when the union of the first authorization status and the second authorization status comply with the authorization criteria. In some embodiments, the union of the first authorization status and the second authorization status complies with the authorization criteria when the union of the first authorization status and the second authorization status includes authorization from each of the first system and the second system for the user to take the action. In some embodiments, the request, and specifically the action requested by the user can be authorized and/or allowed when the union of the first authorization status and the second authorization status includes authorization from at least one of the first system and the second system for the user to take the action. In some embodiments, the request, and specifically the action requested by the user can be denied and/or prohibited when the union of the first authorization status and the second authorization status does not comply with the authorization criteria. In some embodiments, the union of the first authorization status and the second authorization status does not comply with the authorization criteria when the union of the first authorization status and the second authorization status includes at least one denial of authorization from at least one of the first system and the second system.

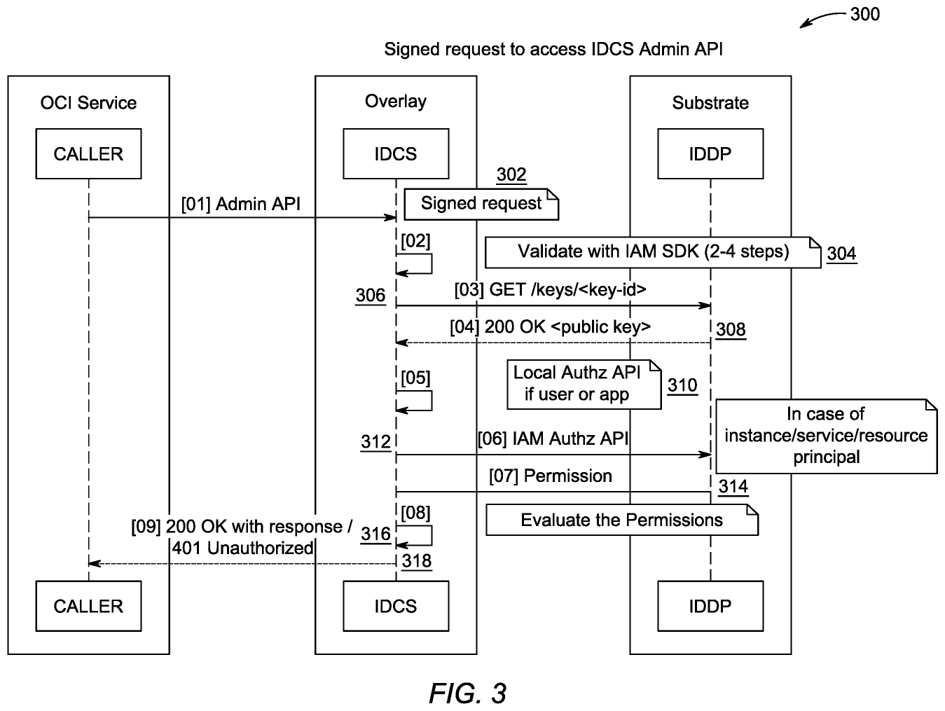

With reference now to FIG. 3, a flowchart illustrating another embodiment of a process 300 for combined authorization for entities within a domain is shown. The process 300 can be performed by all or portions of the combined authorization system 100, and specifically can be performed by one or several of the IDCS servers 106 and/or by one or several of the IAM servers 104.

The process 300 begins at step 302, wherein a user makes a request via an IDCS application, and specifically via an IDCS API to take an action in IDCS. The user can, in some embodiments, be a principal. The request can, for example, a signed request. The request can include information such as, for example: identification of the user principal, including, an API key, a native token or identity, a federated token or identity, or the like; identification of the instance, service, and/or resource principal; identification of an instance principal and/or an Oauth OBO flow.

At step 304, IDCS determines the identity of the principal and/or user, and determines the identity of the requested IDCS API. In some embodiments, this can include validating the signed request and deriving the principal involved. In some embodiments, IDCS can use IAM to validate the signed request and to derive the principal involved. In such an embodiment, and as part of the signed request validation, IAM ca request and/or receive the public key corresponding to the signed request from the data plane as indicated in step 306. At step 308, the public key is received and used to validate the signed request. In some embodiments, the public key can be used by IAM to validate the signed request.

At step 310, and if the principal is a user principal, then IDCS performs a domain-specific authorization based on IDCS authorization policies. At step 312, IDCS requests that IAM evaluate the request. In some embodiments, IDCS requests that IAM evaluate the request according to IAM authorization policies. IAM evaluates the request according to IAM's authorization policies. At step 314, IDCS receives permissions from IAM. In some embodiments, this can include receiving the results of the evaluation of the request of step 302 according to IAM's authorization policies. At step 316, the permissions are evaluated. This can include determining the union of the permissions received from IAM and the results of the evaluation at step 310. At step 318, a response is provided to the user, the response either indicating that the request of step 302 is authorized, or that the request is unauthorized.

### Exemplary Embodiment

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

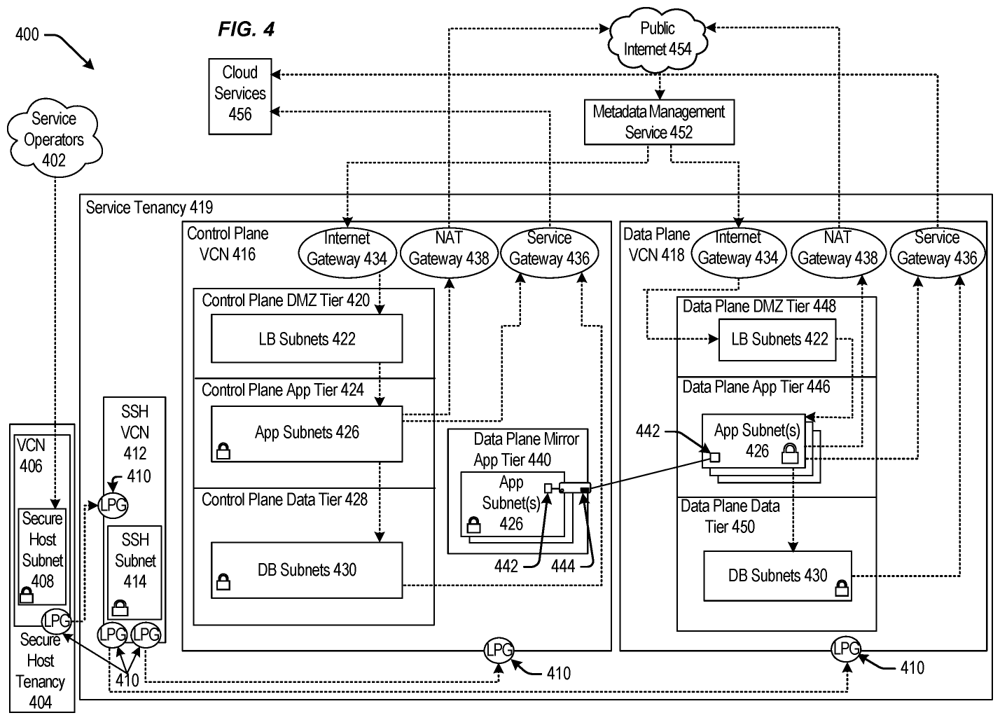

FIG. 4 is a block diagram 400 illustrating an example pattern of an IaaS architecture, according to at least one embodiment. Service operators 402 can be communicatively coupled to a secure host tenancy 404 that can include a virtual cloud network (VCN) 406 and a secure host subnet 408. In some examples, the service operators 402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 406 and/or the Internet.

The VCN 406 can include a local peering gateway (LPG) 410 that can be communicatively coupled to a secure shell (SSH) VCN 412 via an LPG 410 contained in the SSH VCN 412. The SSH VCN 412 can include an SSH subnet 414, and the SSH VCN 412 can be communicatively coupled to a control plane VCN 416 via the LPG 410 contained in the control plane VCN 416. Also, the SSH VCN 412 can be communicatively coupled to a data plane VCN 418 via an LPG 410. The control plane VCN 416 and the data plane VCN 418 can be contained in a service tenancy 419 that can be owned and/or operated by the IaaS provider.

The control plane VCN 416 can include a control plane demilitarized zone (DMZ) tier 420 that acts as a perimeter network (e.g., portions of a corporate network between the corporate intranet and external networks). The DMZ-based servers may have restricted responsibilities and help keep breaches contained. Additionally, the DMZ tier 420 can include one or more load balancer (LB) subnet(s) 422, a control plane app tier 424 that can include app subnet(s) 426, a control plane data tier 428 that can include database (DB) subnet(s) 430 (e.g., frontend DB subnet(s) and/or backend DB subnet(s)). The LB subnet(s) 422 contained in the control plane DMZ tier 420 can be communicatively coupled to the app subnet(s) 426 contained in the control plane app tier 424 and an Internet gateway 434 that can be contained in the control plane VCN 416, and the app subnet(s) 426 can be communicatively coupled to the DB subnet(s) 430 contained in the control plane data tier 428 and a service gateway 436 and a network address translation (NAT) gateway 438. The control plane VCN 416 can include the service gateway 436 and the NAT gateway 438.

The control plane VCN 416 can include a data plane mirror app tier 440 that can include app subnet(s) 426. The app subnet(s) 426 contained in the data plane mirror app tier 440 can include a virtual network interface controller (VNIC) 442 that can execute a compute instance 444. The compute instance 444 can communicatively couple the app subnet(s) 426 of the data plane mirror app tier 440 to app subnet(s) 426 that can be contained in a data plane app tier 446.

The data plane VCN 418 can include the data plane app tier 446, a data plane DMZ tier 448, and a data plane data tier 450. The data plane DMZ tier 448 can include LB subnet(s) 422 that can be communicatively coupled to the app subnet(s) 426 of the data plane app tier 446 and the Internet gateway 434 of the data plane VCN 418. The app subnet(s) 426 can be communicatively coupled to the service gateway 436 of the data plane VCN 418 and the NAT gateway 438 of the data plane VCN 418. The data plane data tier 450 can also include the DB subnet(s) 430 that can be communicatively coupled to the app subnet(s) 426 of the data plane app tier 446.

The Internet gateway 434 of the control plane VCN 416 and of the data plane VCN 418 can be communicatively coupled to a metadata management service 452 that can be communicatively coupled to public Internet 454. Public Internet 454 can be communicatively coupled to the NAT gateway 438 of the control plane VCN 416 and of the data plane VCN 418. The service gateway 436 of the control plane VCN 416 and of the data plane VCN 418 can be communicatively couple to cloud services 456.

In some examples, the service gateway 436 of the control plane VCN 416 or of the data plane VCN 418 can make application programming interface (API) calls to cloud services 456 without going through public Internet 454. The API calls to cloud services 456 from the service gateway 436 can be one-way: the service gateway 436 can make API calls to cloud services 456, and cloud services 456 can send requested data to the service gateway 436. But, cloud services 456 may not initiate API calls to the service gateway 436.

In some examples, the secure host tenancy 404 can be directly connected to the service tenancy 419, which may be otherwise isolated. The secure host subnet 408 can communicate with the SSH subnet 414 through an LPG 410 that may enable two-way communication over an otherwise isolated system. Connecting the secure host subnet 408 to the SSH subnet 414 may give the secure host subnet 408 access to other entities within the service tenancy 419.

The control plane VCN 416 may allow users of the service tenancy 419 to set up or otherwise provision desired resources. Desired resources provisioned in the control plane VCN 416 may be deployed or otherwise used in the data plane VCN 418. In some examples, the control plane VCN 416 can be isolated from the data plane VCN 418, and the data plane mirror app tier 440 of the control plane VCN 416 can communicate with the data plane app tier 446 of the data plane VCN 418 via VNICs 442 that can be contained in the data plane mirror app tier 440 and the data plane app tier 446.

In some examples, users of the system, or customers, can make requests, for example create, read, update, or delete (CRUD) operations, through public Internet 454 that can communicate the requests to the metadata management service 452. The metadata management service 452 can communicate the request to the control plane VCN 416 through the Internet gateway 434. The request can be received by the LB subnet(s) 422 contained in the control plane DMZ tier 420. The LB subnet(s) 422 may determine that the request is valid, and in response to this determination, the LB subnet(s) 422 can transmit the request to app subnet(s) 426 contained in the control plane app tier 424. If the request is validated and requires a call to public Internet 454, the call to public Internet 454 may be transmitted to the NAT gateway 438 that can make the call to public Internet 454. Metadata that may be desired to be stored by the request can be stored in the DB subnet(s) 430.

In some examples, the data plane mirror app tier 440 can facilitate direct communication between the control plane VCN 416 and the data plane VCN 418. For example, changes, updates, or other suitable modifications to configuration may be desired to be applied to the resources contained in the data plane VCN 418. Via a VNIC 442, the control plane VCN 416 can directly communicate with, and can thereby execute the changes, updates, or other suitable modifications to configuration to, resources contained in the data plane VCN 418.

In some embodiments, the control plane VCN 416 and the data plane VCN 418 can be contained in the service tenancy 419. In this case, the user, or the customer, of the system may not own or operate either the control plane VCN 416 or the data plane VCN 418. Instead, the IaaS provider may own or operate the control plane VCN 416 and the data plane VCN 418, both of which may be contained in the service tenancy 419. This embodiment can enable isolation of networks that may prevent users or customers from interacting with other users', or other customers', resources. Also, this embodiment may allow users or customers of the system to store databases privately without needing to rely on public Internet 454, which may not have a desired level of threat prevention, for storage.

In other embodiments, the LB subnet(s) 422 contained in the control plane VCN 416 can be configured to receive a signal from the service gateway 436. In this embodiment, the control plane VCN 416 and the data plane VCN 418 may be configured to be called by a customer of the IaaS provider without calling public Internet 454. Customers of the IaaS provider may desire this embodiment since database(s) that the customers use may be controlled by the IaaS provider and may be stored on the service tenancy 419, which may be isolated from public Internet 454.

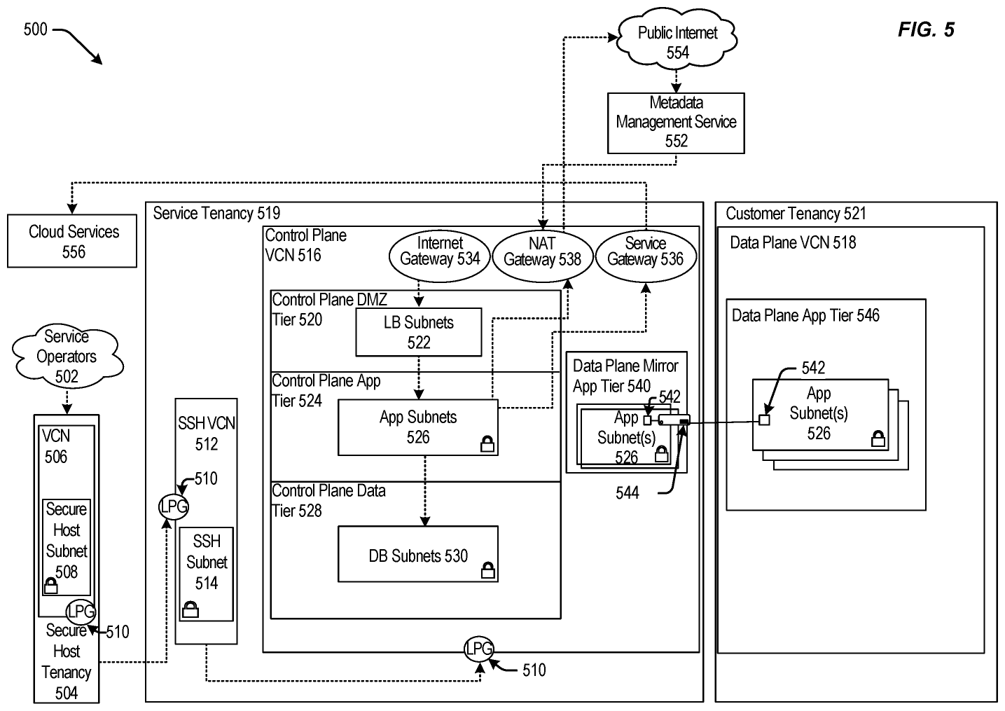

FIG. 5 is a block diagram 500 illustrating another example pattern of an IaaS architecture, according to at least one embodiment. Service operators 502 (e.g., service operators 402 of FIG. 4) can be communicatively coupled to a secure host tenancy 504 (e.g., the secure host tenancy 404 of FIG. 4) that can include a virtual cloud network (VCN) 506 (e.g., the VCN 406 of FIG. 4) and a secure host subnet 508 (e.g., the secure host subnet 408 of FIG. 4). The VCN 506 can include a local peering gateway (LPG) 510 (e.g., the LPG 410 of FIG. 4) that can be communicatively coupled to a secure shell (SSH) VCN 512 (e.g., the SSH VCN 412 of FIG. 4) via an LPG 410 contained in the SSH VCN 512. The SSH VCN 512 can include an SSH subnet 514 (e.g., the SSH subnet 414 of FIG. 4), and the SSH VCN 512 can be communicatively coupled to a control plane VCN 516 (e.g., the control plane VCN 416 of FIG. 4) via an LPG 510 contained in the control plane VCN 516. The control plane VCN 516 can be contained in a service tenancy 519 (e.g., the service tenancy 419 of FIG. 4), and the data plane VCN 518 (e.g., the data plane VCN 418 of FIG. 4) can be contained in a customer tenancy 521 that may be owned or operated by users, or customers, of the system.

The control plane VCN 516 can include a control plane DMZ tier 520 (e.g., the control plane DMZ tier 420 of FIG. 4) that can include LB subnet(s) 522 (e.g., LB subnet(s) 422 of FIG. 4), a control plane app tier 524 (e.g., the control plane app tier 424 of FIG. 4) that can include app subnet(s) 526 (e.g., app subnet(s) 426 of FIG. 4), a control plane data tier 528 (e.g., the control plane data tier 428 of FIG. 4) that can include database (DB) subnet(s) 530 (e.g., similar to DB subnet(s) 430 of FIG. 4). The LB subnet(s) 522 contained in the control plane DMZ tier 520 can be communicatively coupled to the app subnet(s) 526 contained in the control plane app tier 524 and an Internet gateway 534 (e.g., the Internet gateway 434 of FIG. 4) that can be contained in the control plane VCN 516, and the app subnet(s) 526 can be communicatively coupled to the DB subnet(s) 530 contained in the control plane data tier 528 and a service gateway 536 (e.g., the service gateway 436 of FIG. 4) and a network address translation (NAT) gateway 538 (e.g., the NAT gateway 438 of FIG. 4). The control plane VCN 516 can include the service gateway 536 and the NAT gateway 538.

The control plane VCN 516 can include a data plane mirror app tier 540 (e.g., the data plane mirror app tier 440 of FIG. 4) that can include app subnet(s) 526. The app subnet(s) 526 contained in the data plane mirror app tier 540 can include a virtual network interface controller (VNIC) 542 (e.g., the VNIC of 442) that can execute a compute instance 544 (e.g., similar to the compute instance 444 of FIG. 4). The compute instance 544 can facilitate communication between the app subnet(s) 526 of the data plane mirror app tier 540 and the app subnet(s) 526 that can be contained in a data plane app tier 546 (e.g., the data plane app tier 446 of FIG. 4) via the VNIC 542 contained in the data plane mirror app tier 540 and the VNIC 542 contained in the data plane app tier 546.

The Internet gateway 534 contained in the control plane VCN 516 can be communicatively coupled to a metadata management service 552 (e.g., the metadata management service 452 of FIG. 4) that can be communicatively coupled to public Internet 554 (e.g., public Internet 454 of FIG. 4). Public Internet 554 can be communicatively coupled to the NAT gateway 538 contained in the control plane VCN 516. The service gateway 536 contained in the control plane VCN 516 can be communicatively couple to cloud services 556 (e.g., cloud services 456 of FIG. 4).

In some examples, the data plane VCN 518 can be contained in the customer tenancy 521. In this case, the IaaS provider may provide the control plane VCN 516 for each customer, and the IaaS provider may, for each customer, set up a unique compute instance 544 that is contained in the service tenancy 519. Each compute instance 544 may allow communication between the control plane VCN 516, contained in the service tenancy 519, and the data plane VCN 518 that is contained in the customer tenancy 521. The compute instance 544 may allow resources, that are provisioned in the control plane VCN 516 that is contained in the service tenancy 519, to be deployed or otherwise used in the data plane VCN 518 that is contained in the customer tenancy 521.

In other examples, the customer of the IaaS provider may have databases that live in the customer tenancy 521. In this example, the control plane VCN 516 can include the data plane mirror app tier 540 that can include app subnet(s) 526. The data plane mirror app tier 540 can reside in the data plane VCN 518, but the data plane mirror app tier 540 may not live in the data plane VCN 518. That is, the data plane mirror app tier 540 may have access to the customer tenancy 521, but the data plane mirror app tier 540 may not exist in the data plane VCN 518 or be owned or operated by the customer of the IaaS provider. The data plane mirror app tier 540 may be configured to make calls to the data plane VCN 518 but may not be configured to make calls to any entity contained in the control plane VCN 516. The customer may desire to deploy or otherwise use resources in the data plane VCN 518 that are provisioned in the control plane VCN 516, and the data plane mirror app tier 540 can facilitate the desired deployment, or other usage of resources, of the customer.

In some embodiments, the customer of the IaaS provider can apply filters to the data plane VCN 518. In this embodiment, the customer can determine what the data plane VCN 518 can access, and the customer may restrict access to public Internet 554 from the data plane VCN 518. The IaaS provider may not be able to apply filters or otherwise control access of the data plane VCN 518 to any outside networks or databases. Applying filters and controls by the customer onto the data plane VCN 518, contained in the customer tenancy 521, can help isolate the data plane VCN 518 from other customers and from public Internet 554.

In some embodiments, cloud services 556 can be called by the service gateway 536 to access services that may not exist on public Internet 554, on the control plane VCN 516, or on the data plane VCN 518. The connection between cloud services 556 and the control plane VCN 516 or the data plane VCN 518 may not be live or continuous. Cloud services 556 may exist on a different network owned or operated by the IaaS provider. Cloud services 556 may be configured to receive calls from the service gateway 536 and may be configured to not receive calls from public Internet 554. Some cloud services 556 may be isolated from other cloud services 556, and the control plane VCN 516 may be isolated from cloud services 556 that may not be in the same region as the control plane VCN 516. For example, the control plane VCN 516 may be located in “Region 1,” and cloud service “Deployment 4,” may be located in Region 1 and in “Region 2.” If a call to Deployment 4 is made by the service gateway 536 contained in the control plane VCN 516 located in Region 1, the call may be transmitted to Deployment 4 in Region 1. In this example, the control plane VCN 516, or Deployment 4 in Region 1, may not be communicatively coupled to, or otherwise in communication with, Deployment 4 in Region 2.

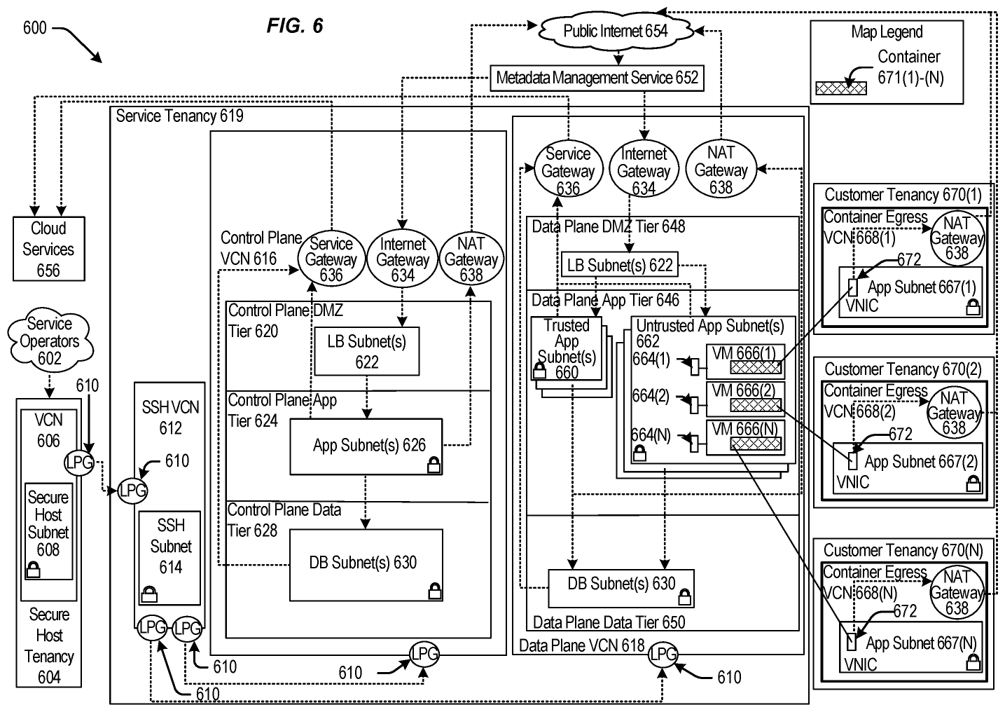

FIG. 6 is a block diagram 600 illustrating another example pattern of an IaaS architecture, according to at least one embodiment. Service operators 602 (e.g., service operators 402 of FIG. 4) can be communicatively coupled to a secure host tenancy 604 (e.g., the secure host tenancy 404 of FIG. 4) that can include a virtual cloud network (VCN) 606 (e.g., the VCN 406 of FIG. 4) and a secure host subnet 608 (e.g., the secure host subnet 408 of FIG. 4). The VCN 606 can include an LPG 610 (e.g., the LPG 410 of FIG. 4) that can be communicatively coupled to an SSH VCN 612 (e.g., the SSH VCN 412 of FIG. 4) via an LPG 610 contained in the SSH VCN 612. The SSH VCN 612 can include an SSH subnet 614 (e.g., the SSH subnet 414 of FIG. 4), and the SSH VCN 612 can be communicatively coupled to a control plane VCN 616 (e.g., the control plane VCN 416 of FIG. 4) via an LPG 610 contained in the control plane VCN 616 and to a data plane VCN 618 (e.g., the data plane 418 of FIG. 4) via an LPG 610 contained in the data plane VCN 618. The control plane VCN 616 and the data plane VCN 618 can be contained in a service tenancy 619 (e.g., the service tenancy 419 of FIG. 4).

The control plane VCN 616 can include a control plane DMZ tier 620 (e.g., the control plane DMZ tier 420 of FIG. 4) that can include load balancer (LB) subnet(s) 622 (e.g., LB subnet(s) 422 of FIG. 4), a control plane app tier 624 (e.g., the control plane app tier 424 of FIG. 4) that can include app subnet(s) 626 (e.g., similar to app subnet(s) 426 of FIG. 4), a control plane data tier 628 (e.g., the control plane data tier 428 of FIG. 4) that can include DB subnet(s) 630. The LB subnet(s) 622 contained in the control plane DMZ tier 620 can be communicatively coupled to the app subnet(s) 626 contained in the control plane app tier 624 and to an Internet gateway 634 (e.g., the Internet gateway 434 of FIG. 4) that can be contained in the control plane VCN 616, and the app subnet(s) 626 can be communicatively coupled to the DB subnet(s) 630 contained in the control plane data tier 628 and to a service gateway 636 (e.g., the service gateway of FIG. 4) and a network address translation (NAT) gateway 638 (e.g., the NAT gateway 438 of FIG. 4). The control plane VCN 616 can include the service gateway 636 and the NAT gateway 638.

The data plane VCN 618 can include a data plane app tier 646 (e.g., the data plane app tier 446 of FIG. 4), a data plane DMZ tier 648 (e.g., the data plane DMZ tier 448 of FIG. 4), and a data plane data tier 650 (e.g., the data plane data tier 450 of FIG. 4). The data plane DMZ tier 648 can include LB subnet(s) 622 that can be communicatively coupled to trusted app subnet(s) 660 and untrusted app subnet(s) 662 of the data plane app tier 646 and the Internet gateway 634 contained in the data plane VCN 618. The trusted app subnet(s) 660 can be communicatively coupled to the service gateway 636 contained in the data plane VCN 618, the NAT gateway 638 contained in the data plane VCN 618, and DB subnet(s) 630 contained in the data plane data tier 650. The untrusted app subnet(s) 662 can be communicatively coupled to the service gateway 636 contained in the data plane VCN 618 and DB subnet(s) 630 contained in the data plane data tier 650. The data plane data tier 650 can include DB subnet(s) 630 that can be communicatively coupled to the service gateway 636 contained in the data plane VCN 618.

The untrusted app subnet(s) 662 can include one or more primary VNICs 664(1)-(N) that can be communicatively coupled to tenant virtual machines (VMs) 666(1)-(N). Each tenant VM 666(1)-(N) can be communicatively coupled to a respective app subnet 667(1)-(N) that can be contained in respective container egress VCNs 668(1)-(N) that can be contained in respective customer tenancies 670(1)-(N). Respective secondary VNICs 672(1)-(N) can facilitate communication between the untrusted app subnet(s) 662 contained in the data plane VCN 618 and the app subnet contained in the container egress VCNs 668(1)-(N). Each container egress VCNs 668(1)-(N) can include a NAT gateway 638 that can be communicatively coupled to public Internet 654 (e.g., public Internet 454 of FIG. 4).

The Internet gateway 634 contained in the control plane VCN 616 and contained in the data plane VCN 618 can be communicatively coupled to a metadata management service 652 (e.g., the metadata management system 452 of FIG. 4) that can be communicatively coupled to public Internet 654. Public Internet 654 can be communicatively coupled to the NAT gateway 638 contained in the control plane VCN 616 and contained in the data plane VCN 618. The service gateway 636 contained in the control plane VCN 616 and contained in the data plane VCN 618 can be communicatively couple to cloud services 656.

In some embodiments, the data plane VCN 618 can be integrated with customer tenancies 670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 646. Code to run the function may be executed in the VMs 666(1)-(N), and the code may not be configured to run anywhere else on the data plane VCN 618. Each VM 666(1)-(N) may be connected to one customer tenancy 670. Respective containers 671(1)-(N) contained in the VMs 666(1)-(N) may be configured to run the code. In this case, there can be a dual isolation (e.g., the containers 671(1)-(N) running code, where the containers 671(1)-(N) may be contained in at least the VM 666(1)-(N) that are contained in the untrusted app subnet(s) 662), which may help prevent incorrect or otherwise undesirable code from damaging the network of the IaaS provider or from damaging a network of a different customer. The containers 671(1)-(N) may be communicatively coupled to the customer tenancy 670 and may be configured to transmit or receive data from the customer tenancy 670. The containers 671(1)-(N) may not be configured to transmit or receive data from any other entity in the data plane VCN 618. Upon completion of running the code, the IaaS provider may kill or otherwise dispose of the containers 671(1)-(N).

In some embodiments, the trusted app subnet(s) 660 may run code that may be owned or operated by the IaaS provider. In this embodiment, the trusted app subnet(s) 660 may be communicatively coupled to the DB subnet(s) 630 and be configured to execute CRUD operations in the DB subnet(s) 630. The untrusted app subnet(s) 662 may be communicatively coupled to the DB subnet(s) 630, but in this embodiment, the untrusted app subnet(s) may be configured to execute read operations in the DB subnet(s) 630. The containers 671(1)-(N) that can be contained in the VM 666(1)-(N) of each customer and that may run code from the customer may not be communicatively coupled with the DB subnet(s) 630.

In other embodiments, the control plane VCN 616 and the data plane VCN 618 may not be directly communicatively coupled. In this embodiment, there may be no direct communication between the control plane VCN 616 and the data plane VCN 618. However, communication can occur indirectly through at least one method. An LPG 610 may be established by the IaaS provider that can facilitate communication between the control plane VCN 616 and the data plane VCN 618. In another example, the control plane VCN 616 or the data plane VCN 618 can make a call to cloud services 656 via the service gateway 636. For example, a call to cloud services 656 from the control plane VCN 616 can include a request for a service that can communicate with the data plane VCN 618.

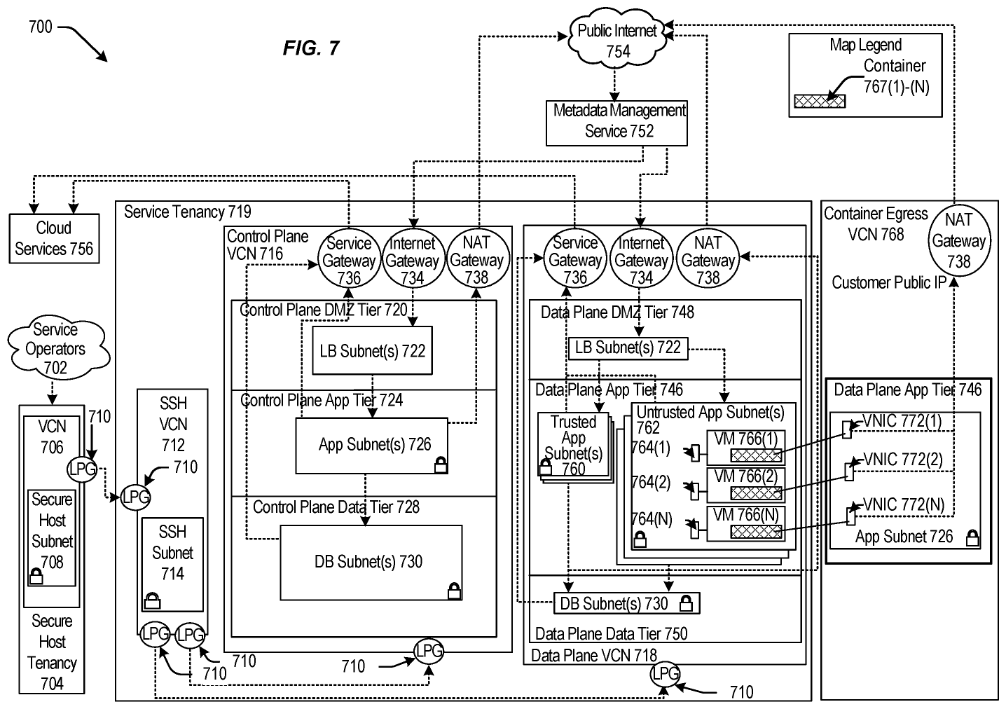

FIG. 7 is a block diagram 700 illustrating another example pattern of an IaaS architecture, according to at least one embodiment. Service operators 702 (e.g., service operators 402 of FIG. 4) can be communicatively coupled to a secure host tenancy 704 (e.g., the secure host tenancy 404 of FIG. 4) that can include a virtual cloud network (VCN) 706 (e.g., the VCN 406 of FIG. 4) and a secure host subnet 708 (e.g., the secure host subnet 408 of FIG. 4). The VCN 706 can include an LPG 710 (e.g., the LPG 410 of FIG. 4) that can be communicatively coupled to an SSH VCN 712 (e.g., the SSH VCN 412 of FIG. 4) via an LPG 710 contained in the SSH VCN 712. The SSH VCN 712 can include an SSH subnet 714 (e.g., the SSH subnet 414 of FIG. 4), and the SSH VCN 712 can be communicatively coupled to a control plane VCN 716 (e.g., the control plane VCN 416 of FIG. 4) via an LPG 710 contained in the control plane VCN 716 and to a data plane VCN 718 (e.g., the data plane 418 of FIG. 4) via an LPG 710 contained in the data plane VCN 718. The control plane VCN 716 and the data plane VCN 718 can be contained in a service tenancy 719 (e.g., the service tenancy 419 of FIG. 4).

The control plane VCN 716 can include a control plane DMZ tier 720 (e.g., the control plane DMZ tier 420 of FIG. 4) that can include LB subnet(s) 722 (e.g., LB subnet(s) 422 of FIG. 4), a control plane app tier 724 (e.g., the control plane app tier 424 of FIG. 4) that can include app subnet(s) 726 (e.g., app subnet(s) 426 of FIG. 4), a control plane data tier 728 (e.g., the control plane data tier 428 of FIG. 4) that can include DB subnet(s) 730 (e.g., DB subnet(s) 630 of FIG. 6). The LB subnet(s) 722 contained in the control plane DMZ tier 720 can be communicatively coupled to the app subnet(s) 726 contained in the control plane app tier 724 and to an Internet gateway 734 (e.g., the Internet gateway 434 of FIG. 4) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 4) and a network address translation (NAT) gateway 738 (e.g., the NAT gateway 438 of FIG. 4). The control plane VCN 716 can include the service gateway 736 and the NAT gateway 738.

The data plane VCN 718 can include a data plane app tier 746 (e.g., the data plane app tier 446 of FIG. 4), a data plane DMZ tier 748 (e.g., the data plane DMZ tier 448 of FIG. 4), and a data plane data tier 750 (e.g., the data plane data tier 450 of FIG. 4). The data plane DMZ tier 748 can include LB subnet(s) 722 that can be communicatively coupled to trusted app subnet(s) 760 (e.g., trusted app subnet(s) 660 of FIG. 6) and untrusted app subnet(s) 762 (e.g., untrusted app subnet(s) 662 of FIG. 6) of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include primary VNICs 764(1)-(N) that can be communicatively coupled to tenant virtual machines (VMs) 766(1)-(N) residing within the untrusted app subnet(s) 762. Each tenant VM 766(1)-(N) can run code in a respective container 767(1)-(N), and be communicatively coupled to an app subnet 726 that can be contained in a data plane app tier 746 that can be contained in a container egress VCN 768. Respective secondary VNICs 772(1)-(N) can facilitate communication between the untrusted app subnet(s) 762 contained in the data plane VCN 718 and the app subnet contained in the container egress VCN 768. The container egress VCN can include a NAT gateway 738 that can be communicatively coupled to public Internet 754 (e.g., public Internet 454 of FIG. 4).

The Internet gateway 734 contained in the control plane VCN 716 and contained in the data plane VCN 718 can be communicatively coupled to a metadata management service 752 (e.g., the metadata management system 452 of FIG. 4) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some examples, the pattern illustrated by the architecture of block diagram 700 of FIG. 7 may be considered an exception to the pattern illustrated by the architecture of block diagram 600 of FIG. 6 and may be desirable for a customer of the IaaS provider if the IaaS provider cannot directly communicate with the customer (e.g., a disconnected region). The respective containers 767(1)-(N) that are contained in the VMs 766(1)-(N) for each customer can be accessed in real-time by the customer. The containers 767(1)-(N) may be configured to make calls to respective secondary VNICs 772(1)-(N) contained in app subnet(s) 726 of the data plane app tier 746 that can be contained in the container egress VCN 768. The secondary VNICs 772(1)-(N) can transmit the calls to the NAT gateway 738 that may transmit the calls to public Internet 754. In this example, the containers 767(1)-(N) that can be accessed in real-time by the customer can be isolated from the control plane VCN 716 and can be isolated from other entities contained in the data plane VCN 718. The containers 767(1)-(N) may also be isolated from resources from other customers.

In other examples, the customer can use the containers 767(1)-(N) to call cloud services 756. In this example, the customer may run code in the containers 767(1)-(N) that requests a service from cloud services 756. The containers 767(1)-(N) can transmit this request to the secondary VNICs 772(1)-(N) that can transmit the request to the NAT gateway that can transmit the request to public Internet 754. Public Internet 754 can transmit the request to LB subnet(s) 722 contained in the control plane VCN 716 via the Internet gateway 734. In response to determining the request is valid, the LB subnet(s) can transmit the request to app subnet(s) 726 that can transmit the request to cloud services 756 via the service gateway 736.

It should be appreciated that IaaS architectures 400, 500, 600, 700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 8 illustrates an example computer system 800, in which various embodiments may be implemented. The system 800 may be used to implement any of the computer systems described above. As shown in the figure, computer system 800 includes a processing unit 804 that communicates with a number of peripheral subsystems via a bus subsystem 802. These peripheral subsystems may include a processing acceleration unit 806, an I/O subsystem 808, a storage subsystem 818 and a communications subsystem 824. Storage subsystem 818 includes tangible computer-readable storage media 822 and a system memory 810.

Bus subsystem 802 provides a mechanism for letting the various components and subsystems of computer system 800 communicate with each other as intended. Although bus subsystem 802 is shown schematically as a single bus, alternative embodiments of the bus subsystem may utilize multiple buses. Bus subsystem 802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 804, which can be implemented as one or more integrated circuits (e.g., a conventional microprocessor or microcontroller), controls the operation of computer system 800. One or more processors may be included in processing unit 804. These processors may include single core or multicore processors. In certain embodiments, processing unit 804 may be implemented as one or more independent processing units 832 and/or 834 with single or multicore processors included in each processing unit. In other embodiments, processing unit 804 may also be implemented as a quad-core processing unit formed by integrating two dual-core processors into a single chip.

In various embodiments, processing unit 804 can execute a variety of programs in response to program code and can maintain multiple concurrently executing programs or processes. At any given time, some or all of the program code to be executed can be resident in processor(s) 804 and/or in storage subsystem 818. Through suitable programming, processor(s) 804 can provide various functionalities described above. Computer system 800 may additionally include a processing acceleration unit 806, which can include a digital signal processor (DSP), a special-purpose processor, and/or the like.

/O subsystem 808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, web cams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 800 may comprise a storage subsystem 818 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 804 provide the functionality described above. Storage subsystem 818 may also provide a repository for storing data used in accordance with the present disclosure.

As depicted in the example in FIG. 8, storage subsystem 818 can include various components including a system memory 810, computer-readable storage media 822, and a computer readable storage media reader 820. System memory 810 may store program instructions that are loadable and executable by processing unit 804. System memory 810 may also store data that is used during the execution of the instructions and/or data that is generated during the execution of the program instructions. Various different kinds of programs may be loaded into system memory 810 including but not limited to client applications, Web browsers, mid-tier applications, relational database management systems (RDBMS), virtual machines, containers, etc.

System memory 810 may also store an operating system 816. Examples of operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 800 executes one or more virtual machines, the virtual machines along with their guest operating systems (GOSs) may be loaded into system memory 810 and executed by one or more processors or cores of processing unit 804.

System memory 810 can come in different configurations depending upon the type of computer system 800. For example, system memory 810 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 810 may include a basic input/output system (BIOS) containing basic routines that help to transfer information between elements within computer system 800, such as during start-up.

Computer-readable storage media 822 may represent remote, local, fixed, and/or removable storage devices plus storage media for temporarily and/or more permanently containing, storing, computer-readable information for use by computer system 800 including instructions executable by processing unit 804 of computer system 800.

Computer-readable storage media 822 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 800.

Machine-readable instructions executable by one or more processors or cores of processing unit 804 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 824 provides an interface to other computer systems and networks. Communications subsystem 824 serves as an interface for receiving data from and transmitting data to other systems from computer system 800. For example, communications subsystem 824 may enable computer system 800 to connect to one or more devices via the Internet. In some embodiments communications subsystem 824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 824 can provide wired network connectivity (e.g., Ethernet) in addition to or instead of a wireless interface.

In some embodiments, communications subsystem 824 may also receive input communication in the form of structured and/or unstructured data feeds 826, event streams 828, event updates 830, and the like on behalf of one or more users who may use computer system 800.

By way of example, communications subsystem 824 may be configured to receive data feeds 826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 824 may also be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to output the structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving a request for a user to take an action in a first system;
determining a first authorization status of the action by the user with the first system;
determining a second authorization status of the action by the user with a second system;
determining a union of the first authorization status and the second authorization status; and
comparing the union of the first authorization status and the second authorization status to authorization criteria.

2. The method of claim 1, further comprising allowing the action by the user when the union of the first authorization status and the second authorization status comply with the authorization criteria.

3. The method of claim 2, wherein the union of the first authorization status and the second authorization status complies with the authorization criteria when the union of the first authorization status and the second authorization status comprises authorization from each of the first system and the second system for the user to take the action.

4. The method of claim 2, further comprising allowing the action by the user when the union of the first authorization status and the second authorization status comprises authorization from at least one of the first system and the second system for the user to take the action.

5. The method of claim 1, further comprising denying the action by the user when the union of the first authorization status and the second authorization status does not comply with the authorization criteria.

6. The method of claim 5, wherein the union of the first authorization status and the second authorization status does not comply with the authorization criteria when the union of the first authorization status and the second authorization status comprises a denial of authorization from at least one of the first system and the second system.

7. The method of claim 1, wherein the first system comprises a role-based access control (RBAC) system, and wherein the second system comprises an attribute-based access control (ABAC) system.

8. The method of claim 7, wherein receiving the request for the user to take the action in the first system comprises receiving a signed request from a first application associated with the first system.

9. The method of claim 8, wherein receiving the request for the user to take the action in the first system comprises receiving information identifying: the first application; the user; the action; and an endpoint to be affected by the action.

10. The method of claim 9, wherein the first system validates the signed request and derives an involved principal with the second system based on at least one of: the received signed request; and the received information.

11. The method of claim 10, wherein validating the signed request comprises: the second system requesting and receiving a public key from a data plane; and validating the signed request with the public key.

12. The method of claim 11, wherein determining the first authorization status of the action by the user with the first system comprises determining a domain-specific authorization of the involved principal.

13. The method of claim 12, wherein the domain-specific authorization of the involved principal is determined according to authorization policies of the first system.

14. The method of claim 10, wherein determining the first authorization status of the action by the user with the first system comprises evaluating the request to take action according to authorization policies of the first system, and wherein determining the second authorization status of the action by the user with the second system comprises: mapping the authorization policy of the first system to a corresponding authorization policy of the second system based at least in part on the received information.

15. The method of claim 14, wherein evaluating the request to take action according to authorization policies of the first system comprises: identifying a role of the user and a domain of the user; retrieving permissions associated with the role of the user and the domain of the user; and determining that the received information identifies an action allowed by the retrieved permissions.

16. The method of claim 15, wherein determining the second authorization status of the action by the user with the second system further comprises: determining a principal of the user; retrieve access policies relevant to the received request; determining that the received request identifies an action allowed by the retrieved access policies.

17. A system comprising:
a first access control system comprising:
at least one first processor; and
a memory comprising a plurality of instructions executable by the at least one first processor, and
a second access control system, wherein the second access control system is configured to determine a second authorization status for a requested user action,
wherein the first access control system is configured to:
receive a request for a user to take an action in the first access control system;
determine a first authorization status of the action by the user;
receive authorization information for the action from the second system;
determine a union of the first authorization status and the second authorization status; and
compare the union of the first authorization status and the second authorization status to authorization criteria.

18. The system of claim 17, wherein receiving the request for the user to take the action in the first system comprises receiving a signed request from a first application associated with the first system, and receiving information identifying: the first application; the user; the action; and an endpoint to be affected by the action, and wherein the first system validates the signed request and derives an involved principal with the second system based on at least one of: the received signed request; and the received information.

19. A non-transitory computer-readable storage medium storing a plurality of instructions executable by one or more processors, the plurality of instructions when executed by the one or more processors cause the one or more processors to:
receive a request for a user to take an action in a first system;
determine a first authorization status of the action by the user with the first system;
determine a second authorization status of the action by the user with a second system;
determine a union of the first authorization status and the second authorization status; and
compare the union of the first authorization status and the second authorization status to authorization criteria.

20. The non-transitory computer-readable storage medium of claim 19, wherein receiving the request for the user to take the action in the first system comprises receiving a signed request from a first application associated with the first system, and receiving information identifying: the first application; the user; the action; and an endpoint to be affected by the action, and wherein the first system validates the signed request and derives an involved principal with the second system based on at least one of: the received signed request; and the received information.
